(19) United States
(12) Patent Application Publication
(10) Pub. No.: US 2015/0017550 A1
(43) Pub. Date: Jan. 15, 2015

(54) METAL THREE-DIMENSIONAL NETWORK POROUS BODY FOR COLLECTORS, ELECTRODE, AND NON-AQUEOUS ELECTROLYTE SECONDARY BATTERY

(71) Applicant: SUMITOMO ELECTRIC INDUSTRIES, LTD., Osaka-shi, Osaka (JP)

(72) Inventors: Junichi Nishimura, Osaka-shi (JP); Kazuhiro Gotou, Itami-shi (JP); Akihisa Hosoe, Osaka-shi (JP); Kentarou Yoshida, Itami-shi (JP)

(21) Appl. No.: 14/382,794

(22) PCT Filed: Feb. 22, 2013
(86) PCT No.: PCT/JP2013/054534

§ 371 Date: Sep. 4, 2014

(30) Foreign Application Priority Data
Mar. 22, 2012 (JP) 2012-065139

(51) Int. Cl. H01M 4/70; H01M 4/505; H01M 4/485; H01M 10/0525; H01M 4/38; H01M 10/0562; H01M 4/66; H01M 4/525; H01M 4/583

(52) U.S. Cl. CPC H01M 4/70; H01M 4/525; H01M 4/505; H01M 4/485; H01M 4/583; H01M 4/38; H01M 10/0562; H01M 4/661; H01M 10/0525; H01M 2300/0068; H01M 2220/20; H01M 2220/30
USPC 429/322; 429/233; 429/231.3; 429/223; 429/224; 429/231.1; 429/231.8; 429/231.95; 429/231.6; 429/245

(57) ABSTRACT

Provided are a current collector, an electrode, and a nonaqueous electrolyte secondary battery, each of which capable of reducing internal resistance and producing cost. More specifically, provided are: a three-dimensional network metal porous body for a current collector, comprising a sheet-shaped three-dimensional network metal porous body, wherein a degree of porosity of the sheet-shaped three-dimensional network metal porous body is 90% or more and 98% or less, and a 30%-cumulative pore diameter (D30) of the sheet-shaped three-dimensional network metal porous body calculated from a fine pore diameter measurement conducted by a bubble point method is 20 μm or more and 100 μm or less; an electrode using the three-dimensional network metal porous body; and a nonaqueous electrolyte secondary battery including the electrode.

### TECHNICAL FIELD

The present invention relates to an electrode and a current collector having a three-dimensional network metal porous body, and a secondary battery having the electrode.

### BACKGROUND ART

In recent years, there has been a demand for high energy density in batteries used as an electric power supply for portable electronic equipment such as a mobile phone and a smart phone, and an electric vehicle and hybrid electric vehicle each having a motor as a source of driving force.

Research has been conducted in a battery that can obtain high energy density including, for example, secondary battery such as a nonaqueous electrolyte secondary battery having characteristics that a capacity is high. Among such secondary batteries, research has been conducted actively in a lithium secondary battery in every field as a battery that can obtain high energy density, since lithium is a substance that has a small atomic weight and large ionization energy.

At present, as a positive electrode of a lithium secondary battery, an electrode in which a compound such as a lithium metal oxide and a lithium metal phosphate is used, is put into practice or in the process of being commercialized the lithium metal oxide including lithium cobalt oxide, lithium manganese oxide, and lithium nickel oxide, and the lithium metal phosphate including lithium iron phosphate. An alloy electrode and an electrode containing carbon, particularly graphite, as a main component are used as a negative electrode. A nonaqueous electrolytic solution obtained by dissolving a lithium salt in an organic solvent is generally used as an electrolyte. In addition, gel electrolytic solutions and solid electrolytes are also gathering attention.

For the purpose of obtaining a high capacity secondary battery, it is proposed to use a current collector having a three-dimensional network structure as a current collector for a lithium secondary battery. Since the current collector has a three-dimensional network structure, the surface area in contact with an active material increases. Therefore, according to the current collector, it is possible to reduce internal resistance and improve battery efficiency of the lithium secondary battery. In addition, according to the current collector, it is possible to improve circulation of an electrolytic solution and prevent concentration of current and formation of a Li dendrite which has been conventionally problematic. Therefore, reliability of the battery can be improved. Furthermore, according to current collector, it is possible to suppress heat generation and increase the output of the battery. Additionally, since the current collector has concave-convex on the skeleton surface of the current collector, the current collector can improve retention of the active material, suppress elimination of the active material, ensure a large specific surface area, improve utilization efficiency of the active material, and provide a battery with higher capacity.

Patent Literature 1 discloses that a valve metal is used as a porous current collector, wherein the valve metal has an oxide coating formed on a surface of any one of simple substances of aluminum, tantalum, niobium, titanium, hafnium, zirconium, zinc, tungsten, bismuth, and antimony, or an alloy or stainless alloy thereof.

Patent Literature 2 discloses that a metal porous body is used as a current collector, wherein the metal porous body is obtained by subjecting a skeleton surface of a synthetic resin having a three-dimensional network structure to a primary conductive treatment by non-electrolytic plating, chemical vapor deposition (CVD), physical vapor deposition (PVD), metal coating, and graphite coating, and further subjecting the skeleton surface to a metallization treatment by electroplating.

It is said that a material of a current collector of a positive electrode for a general-purpose lithium-based secondary battery is preferably aluminum. However, since aluminum has a lower standard electrode potential than hydrogen, water is electrolyzed prior to plating of aluminum in an aqueous solution. Therefore, it is difficult to plate aluminum in an aqueous solution. Accordingly, in the invention disclosed in Patent Literature 3, an aluminum porous body is used as a current collector for batteries, wherein the aluminum porous body obtained by forming an aluminum coating on the surface of a polyurethane foam with molten salt plating, and then removing the polyurethane foam.

An organic electrolytic solution is used as an electrolytic solution for current lithium-ion secondary batteries. However, although the organic electrolytic solution exhibits high ionic conductivity, the organic electrolytic solution is a flammable liquid. Therefore, installation of a protection circuit for the lithium-ion secondary battery can become necessary when the organic electrolytic solution is used as an electrolytic solution of a battery. In addition, when the organic electrolytic solution is used as the electrolytic solution of the battery, a metal negative electrode becomes passivated through reaction with the organic electrolytic solution, resulting in an increase in impedance. As a result, current becomes concentrated at a portion with low impedance to generate a dendrite. In addition, the dendrites penetrate a separator present between the positive electrode and the negative electrode. Therefore, the dendrite penetrates a separator existing between positive and negative electrodes, Therefore, a case of internal short-circuit of a battery occur easily.

Thus, for the purpose of further improving safety and increasing performance of a lithium ion secondary battery, and solving the above described problems, a lithium-ion secondary battery in which a safer inorganic solid electrolyte is used in place of the organic electrolytic solution is studied. Since the inorganic solid electrolyte is generally nonflammable and has high heat resistance, development of a lithium secondary battery using an inorganic solid electrolyte is desired.

For example, Patent Literature 4 discloses that lithium ion conductive sulfide ceramic is used as an electrolyte of an all-solid battery, wherein lithium ion conductive sulfide ceramic includes Li₂S and P₂S₅ and has the composition of 82.5 to 92.5 of Li₂S and 7.5 to 17.5 of P₂S₅ in terms of % by mole.

Furthermore, Patent Literature 5 discloses that highly ion conductive ionic glass, in which an ionic liquid is introduced into ionic glass represented by the formula MₐX-M_{b}Y (wherein M is an alkali metal atom, X and Y are respectively selected from SO₄, BO₃, PO₄, GeO₄, WO₄, MoO₄, SiO₄, NO₃, BS₃, PS₄, SiS₄, and GeS₄, “a” is a valence of X anion; and “b” is a valence of Y anion), is used as a solid electrolyte.

Furthermore, Patent Literature 6 discloses an all-solid lithium secondary battery including a positive electrode containing as a positive electrode active material, a compound selected from the group consisting of transition metal oxides and transition metal sulfides; a lithium ion conductive glass solid electrolyte containing Li₂S; and a negative electrode containing a metal that forms an alloy with lithium as an active material, wherein at least one of the positive electrode active material and the active material of the negative electrode metal contains lithium.

Furthermore, Patent Literature 7 that an electrode material sheet is used as an electrode material used for an all-solid lithium ion secondary battery, wherein the electrode material sheet is formed by inserting an inorganic solid electrolyte into pores of a porous metal sheet having a three-dimensional network structure, in order to improve the flexibility and mechanical strength of an electrode material layer in an all-solid battery to suppress lack and cracks of the electrode material and peeling of the electrode material from the current collector, and in order to improve the contact property between the current collector and the electrode material as well as the contact property between electrode materials.

A conventional three-dimensional network metal porous body is generally produced by forming a metal coating on the surface of the base material with a use of a polyurethane foam as a base material, and then removing the polyurethane foam from the resulting metal-base material complex.

However, there is a case where a lithium ion secondary battery in which a three-dimensional network metal porous body thus produced is used as a current collector for an electrode exhibits high internal resistance and therefore output of the lithium ion secondary battery is not improved. Since it is necessary to add, to such a lithium ion secondary battery, a conduction aid together with an active material, in order to reduce internal resistance, a problem arises regarding high cost.

### CITATION LIST

### Patent Literature

PATENT LITERATURE 1: Japanese Laid-Open Patent Publication No. 2005-78991

PATENT LITERATURE 2: Japanese Laid-Open Patent Publication No. 7-22021

PATENT LITERATURE 3: WO2011/118460

PATENT LITERATURE 4: Japanese Laid-Open Patent Publication No. 2001-250580

PATENT LITERATURE 5: Japanese Laid-Open Patent Publication No. 2006-156083

PATENT LITERATURE 6: Japanese Laid-Open Patent Publication No. 8-148180

PATENT LITERATURE 7: Japanese Laid-Open Patent Publication No. 2010-40218

### SUMMARY OF INVENTION

### Technical Problem

An objective of the present invention is to reduce internal resistance of a secondary battery such as a lithium secondary battery having a three-dimensional network metal porous body as a current collector, and reduce producing cost of the battery by not requiring a conduction aid.

### Solution to Problem

As a result of intensive study by the present inventors in order to solve the above-mentioned problems, the present inventors found that the problems can be solved by using in a secondary battery, a three-dimensional network metal porous body having a specific pore diameter as a current collector, a three-dimensional network metal porous body. Then, these findings have now led to completion of the present invention.

Thus, the present invention relates to a three-dimensional network metal porous body for a current collector of an electrode of a battery as described below, an electrode having the three-dimensional network metal porous body, and a secondary battery having the electrode.

(1) A three-dimensional network metal porous body for a current collector, including a sheet-shaped three-dimensional network metal porous body, wherein a degree of porosity of the sheet-shaped three-dimensional network metal porous body is 90% or more and 98% or less, and a 30%-cumulative pore diameter (D30) of the sheet-shaped three-dimensional network metal porous body calculated by carrying out a fine pore diameter measurement with a bubble point method is 20 μm or more and 100 μm or less.

(2) The three-dimensional network metal porous body for a current collector according to the item (1), wherein the 30%-cumulative pore diameter (D30) is 20 μm or more and 60 μm or less.

(3) The three-dimensional network metal porous body for a current collector according to the item (1) or (2), wherein the sheet-shaped three-dimensional network metal porous body is obtained by forming a metal coating on a nonwoven fabric, and then degrading to remove the nonwoven fabric.

(4) An electrode comprising the three-dimensional network metal porous body for a current collector, according to any one of the items (1) to (3), wherein the three-dimensional network metal porous body for a current collector is filled with an active material or a mixture of an active material and a nonaqueous electrolyte.

(5) A nonaqueous electrolyte secondary battery comprising a positive electrode, a negative electrode, and a nonaqueous electrolyte, wherein the positive electrode and/or the negative electrode are/is the electrode according to the item (4).

(6) The nonaqueous electrolyte secondary battery according to the item (5), wherein:

an active material of the positive electrode is at least one material selected from the group consisting of lithium cobalt oxide (LiCoO₂), lithium nickel oxide (LiNiO₂), lithium nickel cobalt oxide (LiCoₓNi₁₋ₓO₂; 0<x<1), lithium manganese oxide (LiMn₂O₄), and a lithium manganese oxide compound (LiM_{y}Mn_{2-y}O₄; M=Cr, Co, or Ni; 0<y<1); and

an active material of the negative electrode is graphite, lithium titanium oxide (Li₄Ti₅O₁₂), or a metal selected from the group consisting of Li, In, Al, Si, Sn, Mg, and Ca, or an alloy containing at least one of the metals.

(7) The nonaqueous electrolyte secondary battery according to the item (5) or (6), wherein the nonaqueous electrolyte is a solid electrolyte.

(8) The nonaqueous electrolyte secondary battery according to the item (7), wherein the solid electrolyte is a sulfide solid electrolyte containing lithium, phosphorus, and sulfur as constituent elements.

(9) The nonaqueous electrolyte secondary battery according to the item (7) or (8), wherein a three-dimensional network metal porous body for a current collector of the positive electrode comprising aluminum, and a three-dimensional network metal porous body for a current collector of the negative electrode comprising copper.

(10) The nonaqueous electrolyte secondary battery according to the item (9), wherein the three-dimensional network metal porous body for a current collector of the positive electrode is obtained by forming an aluminum coating on a surface of a nonwoven fabric through molten salt plating to obtain a complex of the nonwoven fabric and the aluminum coating, and then degrading to remove the nonwoven fabric from the complex.

### Advantageous Effects of Invention

A secondary battery having the current collector of the present invention has a high output because of having a small internal resistance, and also exhibits effect of reducing producing cost.

### BRIEF DESCRIPTION OF DRAWINGS

FIG. 1 schematically shows the basic configuration of a secondary battery having a nonaqueous electrolytic solution.

FIG. 2 schematically shows the basic configuration of an all-solid secondary battery.

FIG. 3 is an outline explanatory view of a bubble point method.

### DESCRIPTION OF EMBODIMENTS

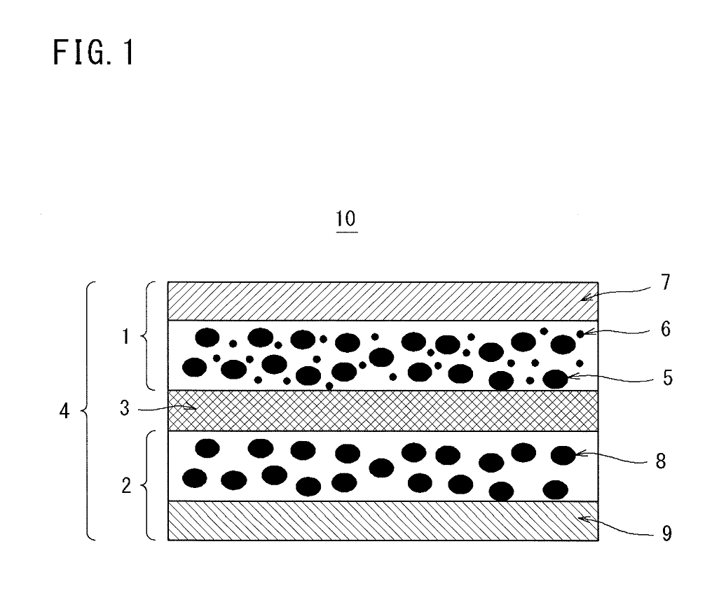

FIG. 1 is a schematic diagram showing the basic configuration of a secondary battery having a nonaqueous electrolytic solution. Hereinafter, a lithium ion secondary battery will be described as an example of a secondary battery 10. The secondary battery 10 shown in FIG. 1 includes a positive electrode 1, a negative electrode 2, and a separator (ionic conduction layer) 3 sandwiched between the two electrodes 1 and 2. In the secondary battery 10, as the positive electrode 1, there is used an electrode obtained by mixing a positive electrode active material powder 5 such as a lithium-cobalt complex oxide with a conductive powder 6 and a binder resin, and then allowing the mixture to be supported by a current collector 7 of positive electrode in a plate-shape. Furthermore, as the negative electrode 2, there is used an electrode obtained by mixing, with a binder resin, a negative electrode active material powder 8 which is a carbon compound, and then allowing the mixture to be supported by a current collector 9 of negative electrode in a plate-like shape. As the separator 3, a micro porous film made of polyethylene, polypropylene or the like is used. In the present embodiment, the separator 3 is impregnated with a nonaqueous electrolytic solution (nonaqueous electrolyte) containing lithium ions. Although not diagrammatically represented, the current collector of positive electrode and the current collector of negative electrode are respectively connected to a positive electrode terminal and a negative electrode terminal with lead wires.

It should be noted that, in the present invention, a solid electrolyte can be used as a nonaqueous electrolyte in place of the nonaqueous electrolytic solution. In this case, a solid electrolyte film can be used in place of the separator 3 for holding the nonaqueous electrolytic solution. An all-solid lithium ion secondary battery can be produced by sandwiching the solid electrolyte film with the positive electrode 1 and the negative electrode 2.

In the present invention, the positive electrode 1 includes a three-dimensional network metal porous body which is the current collector 7 of positive electrode, the positive electrode active material powder 5 filling pores of the three-dimensional network metal porous body, and a conduction aid which is the conductive powder 6.

Furthermore, the negative electrode 2 includes a three-dimensional network metal porous body which is the current collector 9 of negative electrode, and the negative electrode active material powder 8 filling pores of the three-dimensional network metal porous body.

In some cases, a conduction aid can be additionally used to fill the pores of the three-dimensional network metal porous body.

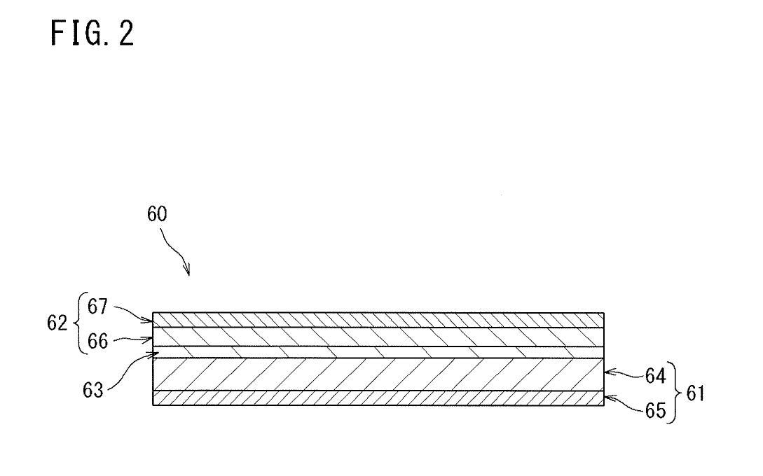

FIG. 2 is a schematic diagram for describing the basic configuration of an all-solid secondary battery. Hereinafter, an all-solid lithium ion secondary battery is described as an example of the all-solid secondary battery.

An all-solid lithium ion secondary battery 60 shown in FIG. 2 includes a positive electrode 61, a negative electrode 62, and a solid electrolyte layer (SE layer) 63 disposed between the two electrodes 61 and 62. The positive electrode 61 includes a positive electrode layer (positive electrode body) 64 and a current collector 65 of positive electrode. The negative electrode 62 includes a negative electrode layer 66 and a current collector 67 of negative electrode.

In the present invention, the positive electrode 61 includes a three-dimensional network metal porous body which is the current collector 65 of positive electrode, and a lithium ion conductive solid electrolyte and a positive electrode active material filling pores of the three-dimensional network metal porous body.

Furthermore, the negative electrode 62 includes a three-dimensional network metal porous body which is the current collector 67 of negative electrode, and a lithium ion conductive solid electrolyte and a negative electrode active material filling pores of the three-dimensional network metal porous body. In some cases, a conduction aid can be additionally used to fill the pores of the three-dimensional network metal porous body.

(Three-Dimensional Network Metal Porous Body)

In the present invention, the three-dimensional network metal porous body is used as a current collector of an electrode of a secondary battery.

In a conventional secondary battery, a three-dimensional network metal porous body used as a current collector is a metal-resin complex porous body or a metal porous body, the metal-resin complex porous body being obtained by forming a metal coating on the surface of a polyurethane foam through a plating method or the like, and the metal porous body being obtained by removing the polyurethane foam from the metal-resin complex porous body.

However, since a polyurethane foam of which pore diameter is 400 to 500 μm is ordinarily used as the polyurethane foam, the pore diameter obtained after forming the metal coating on the surface of the polyurethane foam also is 400 to 500 μm.

On the other hand, the particle diameter of an active material filling the pores of the conventional three-dimensional network metal porous body is 5 to 10 μm. Furthermore, the solid electrolyte filling the pores of the metal porous body together with the active material includes a primary particle and a secondary particle. The primary particle has a particle diameter of 0.1 to 0.5 μm. The secondary particle has a particle diameter of 5 to 20 μm. Thus, since a single pore is filled with a large quantity of the active material and the solid electrolyte, the distance between a skeleton of the pore, and the active material and the solid electrolyte located near the central part of the pore becomes large. Therefore, the internal resistance becomes high, and the output of the battery cannot be improved.

Although the internal resistance can be lowered if the pore diameter is reduced, the pore diameter of the polyurethane foam is at best about 50 μm and it has been difficult to obtain a pore diameter equal to or smaller than that.

The present inventors have found that it is possible to set the pore diameter of the three-dimensional network metal porous body so as to have 10 to 50 μm by using a nonwoven fabric in place of the polyurethane foam when producing the three-dimensional network metal porous body.

The pore diameter of the nonwoven fabric can be adjusted by adjusting a diameter (i.e., fiber diameter) of the fiber used as the material and a fiber density of the nonwoven fabric. Therefore, a three-dimensional network metal porous body having a small pore diameter can be produced by reducing the fiber diameter and increasing the fiber density.

Hereinafter, description will be provided for the nonwoven fabric used for producing the three-dimensional network metal porous body, and a conductive treatment that is to be performed on the nonwoven fabric.

(Nonwoven Fabric)

In the present invention, a nonwoven fabric of a fiber made of a synthetic resin (hereinafter, referred to as “synthetic fiber”) is used as the nonwoven fabric. The synthetic resin used for the synthetic fiber is not particularly limited. As the synthetic resin, a synthetic resin known in the art or a commercially available synthetic resin can be used. Among the synthetic resins, a thermoplastic resin is preferred. Examples of the synthetic fiber include fibers made of olefin homopolymers such as polyethylene, polypropylene, and polybutene, fibers made of olefin copolymers such as ethylene-propylene copolymers, ethylene-butene copolymers, and propylene-butene copolymers, and mixtures of the fibers. Hereinafter, “polyolefin resin fiber” is used as a collective term of fibers made of olefin homopolymers and fibers made of olefin copolymers. Furthermore, “polyolefin resin” is used as a collective term of olefin homopolymers and olefin copolymers. The molecular weight and density of the polyolefin resin comprising the polyolefin resin fiber are not particularly limited, and can be appropriately determined in accordance with the type of the polyolefin resin.

A core-in-sheath composite fiber comprising two components having different melting points can be used as the synthetic fiber.

Such a core-in-sheath composite fiber has excellent strength property because fibers are firmly adhered. In addition, since a conducting path between fibers when a metal coating is formed is ensured sufficiently, the electrical resistance can be reduced.

Concrete examples of the core-in-sheath composite fiber include a PP/PE core-in-sheath composite fiber in which polypropylene (PP) is used as a core component and polyethylene (PE) is used as a sheath component. In this case, the blending ratio (mass ratio) of polypropylene resin:polyethylene resin is ordinarily about 20:80 to 80:20, and is preferably about 40:60 to 70:30.

When a nonwoven fabric in which fibers are not adhered but merely in contact with another is used, the film thickness of a metal coating formed by electroplating becomes uneven, and the electrical resistance can become high due to a part on the surface of the nonwoven fabric not having the metal coating formed thereon. On the other hand, with a nonwoven fabric made of the PP/PE core-sheath composite fiber, the PE at the sheath part has a melting point lower than that of the PP at the core part. Thereafter, a PE layer on the surface layer can be melted while maintaining the porous body structure and adhesion between fibers can be formed firmly through a heat treatment of the nonwoven fabric.

A mean fiber diameter of the synthetic fiber is ordinarily preferably about 5 μm or more and 30 μm or less. A mean fiber length of the synthetic fiber is also not particularly limited, and a mean fiber length is ordinarily preferably about 5 mm or more and 40 mm or less.

The thickness of the nonwoven fabric is ordinarily in a range of about 250 to 1200 μm. However, since a suitable thickness is different depending on the use application of the secondary battery, the thickness can be set as appropriate depending on the use application of the secondary battery. Generally, the thickness of the nonwoven fabric is set to be small in the case of a secondary battery for high output, and is set to be large in the case of a secondary battery for high capacity. The thickness of the nonwoven fabric is preferably 300 to 500 μm in the case of a secondary battery for high output, and is preferably 500 to 800 μm in the case of a secondary battery for high capacity.

As the weight of the nonwoven fabric per unit area, 30 to 100 g/m² is suitable. The degree of porosity of the nonwoven fabric is ordinarily 80 to 96%, and is preferably 88 to 94%.

In the present invention, a 30%-cumulative pore diameter (D30) of the three-dimensional network metal porous body, obtained through a fine pore diameter measurement performed by a bubble point method, is preferably 20 μm or more from the viewpoint of improving the filling performance of an active material, and is preferably 100 μm or less and more preferably 60 μm or less from the viewpoint of improving current collecting performance through reduction of internal resistance and improving battery capacity and high-rate characteristics.

In the present specification, “30%-cumulative pore diameter (D30)” refers to a fine pore diameter (diameter) at which a cumulative fine pore volume from small to large pore diameters reaches 30% of the total volume.

The bubble point method is a method described below.

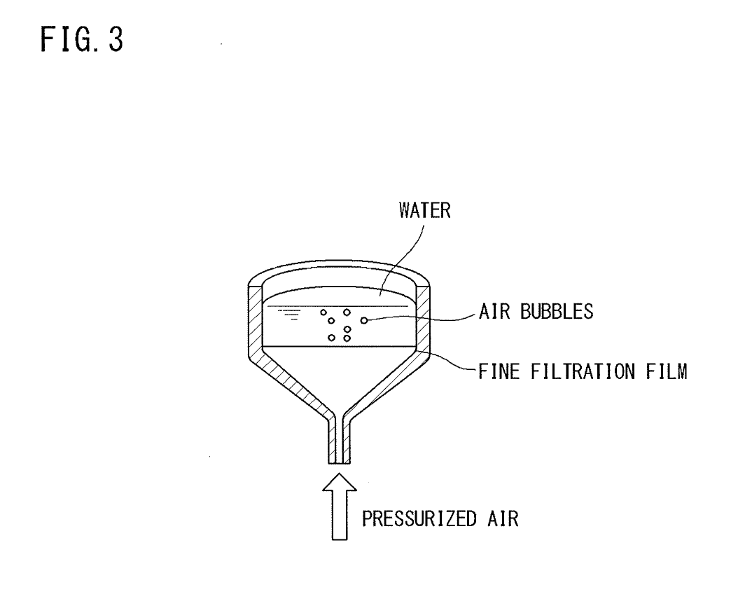

A liquid (water or alcohol) that finely wets a porous body is previously allowed to be absorbed in fine pores, and the porous body is set in an instrument as shown in FIG. 3. Air pressure is applied to the porous body from a reverse side of a film. Thereafter, a pressure at which generation of air bubbles can be observed on the film surface is measured. The “pressure at which generation of air bubbles can be observed on a film surface” is referred to as a bubble point. By using the bubble point, the fine pore diameter can be estimated from the following formula (I) representing a relationship between surface tension of liquid and this pressure. Hereinafter, in the formula (I), d [m] is a fine pore diameter, θ is an angle of contact between a film material and a solvent, γ [N/m] is a surface tension of the solvent, and ΔP [Pa] is a bubble point pressure.

d=4γ cos θ/ΔP (I)

A nonwoven fabric is ordinarily produced by either a known dry method or a known wet method. In the present invention, the nonwoven fabric can be produced by any of the methods. Examples of the dry method include a cart method, an air-lay method, a melt blowing method, a spunbond method, and the like. Examples of the wet method include a method of dispersing a single fiber in water and filtering the dispersed single fiber with a network net. In the present invention, a nonwoven fabric obtained by the wet method is preferably used, from the viewpoint of being able to produce a uniform-thickness current collector with small variation in weight per unit area and thickness.

When forming a metallic film on the surface of the nonwoven fabric, the nonwoven fabric can be used without being pre-treated, or can be used after having a pre-treatment, such as an entangling treatment with a needle punching method, a water stream entangling method, or the like, and a heat treatment at around the softening temperature of a resin fiber, performed on the nonwoven fabric prior to forming a metallic film with a plating method or the like. By carrying out this pre-treatment, the bond between fibers becomes firm, and the strength of the nonwoven fabric can be improved. As a result, a three-dimensional network structure that is required to allow the nonwoven fabric to be filled with an active material can be maintained sufficiently.

In the present invention, when forming the metallic film, a nonwoven fabric having enhanced strength property because of having an entangling treatment performed thereon is preferably used as the nonwoven fabric.

—Conductive Treatment—

In the present invention, in order to form the metal coating more efficiently, a conductive treatment can be performed on the nonwoven fabric prior to a formation of the metal coating.

Examples of the method for forming the metal coating on the surface of the nonwoven fabric include a plating method, a vapor deposition method, a sputtering method, a thermal-spraying method, and the like. Among the methods described above, the plating method is preferably used from the viewpoint of reducing the pore diameter of the three-dimensional network metal porous body of the present invention. In this case, a conductive layer is firstly formed on the surface of the nonwoven fabric.

The conductive layer plays a role of enabling the formation of the metallic film on the surface of the nonwoven fabric with the plating method. Thereafter, the material and thickness of the conductive layer are not particularly limited as long as the conductive layer has a conductive property. The conductive layer can be formed on the surface of the nonwoven fabric by various methods capable of providing the conductive property on the nonwoven fabric. As the method for providing the conductive property on the nonwoven fabric, any method can be used including, for example, a non-electrolytic plating method, a vapor deposition method, a sputtering method, a method of applying a conductive paint containing conductive particles such as carbon particles, and the like.

The material of the conductive layer is preferably the same as that of the metal coating.

The non-electrolytic plating method includes a method known in the art such as a method including the steps of rinsing, activating, and plating.

As the sputtering method, various sputtering methods known in the art, for example, a magnetron sputtering method or the like, can be used. When performing the sputtering method, examples of the material used for forming the conductive layer include aluminum, nickel, chromium, copper, molybdenum, tantalum, gold, aluminum-titanium alloys, nickel-iron alloys, and the like. Among those described above, aluminum, nickel, chromium, copper, and alloys of which main component is any of those are suitable from the viewpoint of cost and the like.

In the present invention, the conductive layer can be a layer containing a powder of at least one type selected from the group consisting of graphite, titanium, and stainless steel. Such conductive layer can be formed by, for example, applying a slurry onto the surface of the nonwoven fabric, the slurry being obtained by mixing a powder such as graphite, titanium, and stainless steel with a binder. In this case, since the powder is hardly oxidized in an organic electrolytic solution, since the powder has oxidation resistance and corrosion resistance. The powder can be used alone or in admixture of not less than two kinds. Among these powders, the powder of graphite is preferred. As the binder, for example, polyvinylidene fluoride (PVDF) and polytetrafluoroethylene (PTFE), which are fluorine resins having excellent electrolytic solution resistance and oxidation resistance are suitable. In the secondary battery of the present invention, since the skeleton of the three-dimensional network metal porous body exists so as to envelope an active material, the content of the binder in the slurry can be about one-half of that in the case where a general-purpose metal foil is used as a current collector, and the content can be set to, for example, about 0.5% by weight.

—Formation of Metal Coatingμ

A metal coating having a desired thickness is formed by thinly forming the conductive layer on the surface of the nonwoven fabric with the above described method, and then performing a plating process on the surface of the nonwoven fabric on which the conductive layer has been formed, to give a metal-nonwoven fabric complex porous body.

Examples of the metal used for forming the metal coating include aluminum, nickel, stainless steel, copper, titanium, and the like.

A coating of a metal other than aluminum can be formed with an ordinary aqueous plating method. Although it is difficult to produce an aluminum coating with a plating method, the aluminum coating can be formed in accordance with a method disclosed in WO2011/118460 by plating, in a molten salt bath, aluminum on the nonwoven fabric (synthetic-resin porous body) of which surface has been rendered conductive.

Thereafter, by removing the nonwoven fabric from the metal-nonwoven fabric complex porous body, the three-dimensional network metal porous body is obtained.

An electrode for secondary batteries is obtained by allowing the current collector comprising the resulting three-dimensional network metal porous body to support the active material for secondary batteries or to support the active material and a solid electrolyte. In the present invention, in addition to the active material, or a mixture of the active material and a solid electrolyte, a conduction aid can be additionally supported on the three-dimensional network metal porous body, as occasion demand. Since the electrode having the three-dimensional network metal porous body of the present invention as a current collector has excellent electric conductivity, it is not particularly necessary to use a conduction aid. When a conduction aid is used, the amount of the conduction aid can be reduced. Hereinafter, the active material and the solid electrolyte are also referred to as “active material etc.”

As a method for allowing the three-dimensional network metal porous body to support the active material etc., there can be used, for example, a method of mixing a binder or the like with the active material or a mixture of the active material and the solid electrolyte to form a slurry, and then filling the current collector with the slurry.

Hereinafter, a case of a lithium secondary battery is used as an example to describe the material of the solid electrolyte and the active material, and describe the method of filling the three-dimensional network metal porous body with the active material.

(Positive Electrode Active Material)

A material capable of insertion or desorption of lithium ions can be used as a positive electrode active material.

Examples of the material of the positive electrode active material include lithium cobalt oxide (LiCoO₂), lithium nickel oxide (LiNiO₂), lithium nickel cobalt oxide (LiCoₓNi₁₋ₓO₂; 0<x<1), lithium manganese oxide (LiMn₂O₄), a lithium manganese oxide compound (LiM_{y}Mn_{2-y}O₄; M=Cr, Co, or Ni; 0<y<1). Other examples of the materials for the positive electrode active material include an olivine compound, for example, lithium transition metal oxide such as lithium iron phosphate (LiFePO₄) and LiFe_{0.5}Mn_{0.5}PO₄, or the like.

Other examples of materials of the positive electrode active material include a lithium metal of which skeleton is a chalcogenide or a metal oxide (i.e., a coordination compound including a lithium atom in a crystal of a chalcogenide or a metal oxide). Examples of the chalcogenide include sulfides such as TiS₂, V₂S₃, FeS, FeS₂, and LiMS_{Z} (wherein M represents a transition metal element (e.g., Mo, Ti, Cu, Ni, Fe), Sb, Sn, or Pb; and “z” is a numerical number of 1.0 or more and 2.5 or less). Examples of the metal oxide include TiO₂, Cr₃O₈, V₂O₅, MnO₂, and the like.

The positive electrode active material can be used in combination with the conduction aid and the binder. When the material of the positive electrode active material is a compound containing a transition metal atom, the transition metal atom contained in the material can be partially substituted with another transition metal atom. The positive electrode active material can be used alone or in admixture of not less than two kinds. From the viewpoint of efficiently inserting and eliminating a lithium ion, preferred one among the positive electrode active materials is at least one selected from the group consisting of lithium cobalt oxide (LiCoO₂), lithium nickel oxide (LiNiO₂), lithium cobalt nickel oxide (LiCoₓNi₁₋ₓO₂; 0<x<1), lithium manganese oxide (LiMn₂O₄) and a lithium manganese oxide compound (LiM_{y}Mn_{2-y}O₄); M=Cr, Co or Ni, 0<y<1). In addition, lithium titanium oxide (Li₄Ti₅O₁₂) among the materials of the positive electrode active material can also be used as a negative electrode active material.

(Negative Electrode Active Material)

A material capable of insertion or disorption of lithium ions can be used as a negative electrode active material. Examples of the negative electrode active material include graphite, lithium titanium oxide (Li₄Ti₅O₁₂), and the like.

Further, as another negative electrode active material, metals such as metal lithium (Li), metal indium (In), metallic aluminum (Al), metallic silicon (Si), metal tin (Sn), metal magnesium (Mn), and metal calcium (Ca); and an alloy formed by combining at least one of the above-mentioned metals and other elements and/or compounds (i.e., an alloy including at least one of the above-mentioned metals) can be employed.

The negative electrode active material can be used alone or in admixture of not less than two kinds. From the viewpoint of performing efficient insertion and disorption of lithium ions and performing efficient formation of an alloy with lithium, preferred ones among the negative electrode active materials are lithium titanium oxide (Li₄Ti₅O₁₂), or a metal selected from the group consisting of Li, In, Al, Si, Sn, Mg, and Ca, or an alloy including at least one of these metals.

(Electrolytic Solution)

In the type of the lithium ion secondary battery shown in FIG. 1, an electrolytic solution obtained by dissolving an electrolyte in a nonaqueous solvent is used. As the electrolytic solution, there can be used a nonaqueous electrolytic solution obtained by dissolving a lithium salt in an organic solvent commonly used in a lithium secondary battery. Examples of the organic solvent include a cyclic carbonic ester such as ethylene carbonate (EC), propylene carbonate (PC), and butylene carbonate (BC); a chain carbonic ester such as dimethyl carbonate (DMC), ethyl methyl carbonate (EMC), and diethyl carbonate (DEC); a cyclic ether such as tetrahydrofuran (THF) and 1,3-dioxolane (DOXL); a chain ether such as 1,2-dimethoxyethane (DME) and 1,2-diethoxyethane (DEE); a cyclic ester such as gamma-butyrolactone (GBL); a chain ester such as methyl acetate (MA), and the like. Examples of the lithium salt include lithium perchlorate (LiClO₄), lithium borofluoride (LiBF₄), lithium hexafluorophosphate (LiPF₆), lithium trifluoromethanesulfonate (LiCF₃SO₃), lithium bis(trifluoromethanesulfonyl)imide (LiN(CF₃SO₂)₂), lithium tris(trifluoromethanesulfonyl)methide (LiC(CF₃SO₂)₃) and the like.

As the separator, as described above, a micro porous film made of a polyolefin such as polyethylene, polypropylene or the like is generally used. Ionic conductivity of an electrolyte in the nonaqueous electrolytic solution is smaller than that of the aqueous electrolytic solution by an order of magnitude. In addition, it is necessary to reduce an inter electrode distance for suppressing voltage reduction at the time of electric discharge. Therefore, a micro porous film made from a thin polyolefin is preferably used.

(Solid Electrolyte to Fill the Metal Three-Dimensional Network Porous Body)

In the type of the lithium ion secondary battery shown in FIG. 2, the solid electrolyte fills, together with the active material, the pores of the three-dimensional network metal porous body. In the present invention, as the solid electrolyte, a sulfide solid electrolyte having high lithium ion conductivity is preferably used. Examples of the sulfide solid electrolyte include a sulfide solid electrolyte containing lithium, phosphorus, and sulfur as constituent elements. The sulfide solid electrolyte can also contain elements such as O, Al, B, Si, and Ge as constituent elements.

Such a sulfide solid electrolyte can be obtained by a known method. Examples of such method include a method of mixing, as starting materials, lithium sulfide (Li₂S) and diphosphorus pentasulfide (P₂S₅) at a mole ratio (Li₂S/P₂S₅) for Li₂S and P₂S₅ of 80/20 to 50/50, and melting and rapidly quenching the resulting mixture (melting and rapid quenching method); a method of mechanically milling the mixture (mechanical milling method), and the like.

The sulfide solid electrolyte obtained by the above-mentioned method is amorphous. In the present invention, for the sulfide solid electrolyte, an amorphous sulfide solid electrolyte can be used, or a crystalline sulfide solid electrolyte obtained by heating the amorphous sulfide solid electrolyte can be used. Improvement of lithium ion conductivity can be expected by crystallization.

(Solid Electrolyte Layer (SE layer))

In the type of the lithium ion secondary battery shown in FIG. 2, a solid electrolyte layer is disposed between the positive electrode and the negative electrode. The solid electrolyte layer can be obtained by forming the solid electrolyte material in a film-like manner.

The layer thickness of the solid electrolyte layer is preferably 1 μm to 500 μm.

(Conduction Aid)

In the present invention, a conduction aid that is commercially available or known in the art can be used as a conduction aid. The conduction aid is not particularly limited, and examples thereof include carbon black such as acetylene black and Ketjenblack; activated carbon; graphite, and the like. When graphite is used as the conduction aid, the shape thereof can be any of forms such as a spherical form, a flake form, a filament form, and a fibriform such as a carbon nanotube (CNT).

(Slurry of Active Material etc.)

A slurry is produced by adding the conduction aid and the binder to the active material and the solid electrolyte as occasion demand, and then mixing the resulting mixture with an organic solvent, water, or the like.

The binder can be one commonly used in the positive electrode for a lithium secondary battery. Examples of the material of the binder include fluorine resins such as PVDF and PTFE; polyolefin resins such as polyethylene, polypropylene, and ethylene-propylene copolymers; and thickening agents (e.g., a water-soluble thickener such as carboxymethyl cellulose, xanthan gum, and pectin agarose).

The organic solvent used in preparing the slurry can be an organic solvent which does not adversely affect materials (i.e., an active material, a conduction aid, a binder, and a solid electrolyte as required) to be filled into the metal porous body, and the organic solvent can be appropriately selected from such organic solvents. Examples of the organic solvents include n-hexane, cyclohexane, heptane, toluene, xylene, trimethyl benzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, N-methyl-2-pyrrolidone and the like. When water is used as a solvent, a surfactant can be used for enhancing the filling performance.

The binder can be mixed with a solvent when forming the slurry, or can be dispersed or dissolved in the solvent in advance. For example, a water-based binder such as an aqueous dispersion of a fluorine resin obtained by dispersing the fluorine resin in water, and an aqueous solution of carboxymethyl cellulose; and an NMP solution of PVDF that is usually used when a metal foil is used as the current collector can be used. In the present invention, since the positive electrode active material comes to have a structure of being enveloped by a conductive skeleton by using a three-dimensional porous body as the current collector, a water-based solvent can be used. In addition, the use and reuse of an expensive organic solvent and environmental consideration become unnecessary. Therefore, it is preferred to use a water-based binder containing at least one binder selected from the group consisting of a fluorine resin, a synthetic rubber and a thickening agent, and a water-based solvent.

The contents of each components in the slurry are not particularly limited, and can be appropriately determined in accordance with the binder and solvent and the like, that are to be used.

(Filling Metal Three-Dimensional Network Porous Body with Active Material Etc.)

The electrode can be produced by filling pores of the three-dimensional network metal porous body with the active material etc. The method for filling the pores of the three-dimensional network metal porous body with the active material etc., can be any method that allows a slurry of the active material etc., to enter the gaps inside the three-dimensional network metal porous body. As such method, for example, a method known in the art such as an immersion filling method or a coating method can be used. Examples of the coating method include a roll coating method, an applicator coating method, an electrostatic coating method, a powder coating method, a spraying coating method, a spray-coater coating method, a bar-coater coating method, a roll-coater coating method, a dip-coater coating method, a doctor-blade coating method, a wire-bar coating method, a knife-coater coating method, a blade coating method, a screen printing method, and the like.

The amount of the active material to be filled is not particularly limited, and the amount can be, for example, about 20 to 100 mg/cm², and preferably 30 to 60 mg/cm².

It is preferred that the electrode is pressed in a state in which the slurry is filled into the current collector.

The thickness of the electrode is ordinarily set to about 100 to 450 μm by the pressing step. The thickness of the electrode is preferably 100 to 250 μm in the case of the electrode of a secondary battery for a high output, and is preferably 250 to 450 μm in the case of the electrode of a secondary battery for a high capacity. A pressing step is preferably performed with a use of a roller press machine. Since the roller press machine is the most effective in smoothing an electrode surface, the possibility of short circuiting can be reduced by pressing the electrode with the roller press machine.

As occasion demand, a heat treatment can be performed after the pressing step when producing the electrode. When the heat treatment is performed, the binder is melted to enable the active material to bind to the three-dimensional network metal porous body more firmly. In addition, the active material is calcined to improve the strength of the active material.

The temperature of the heat treatment is equal to or higher than 100° C. or higher, and preferably 150 to 200° C.

The heat treatment can be performed under ordinary pressure or performed under reduced pressure. However, the heat treatment is preferably performed under reduced pressure. When the heat treatment is performed under reduced pressure, the pressure is, for example, 1000 Pa or less, and preferably 1 to 500 Pa.

The heating time is appropriately determined according to the atmosphere of heating, the pressure and the like. The heating time can be usually 1 to 20 hours and preferably 5 to 15 hours.

Moreover, as occasion demand, a drying step can be performed according to an ordinary method between the filling step and the pressing step.

It should be noted that, in an electrode of a conventional lithium ion secondary battery, the active material is applied on the surface of a metal foil, and the application thickness of the active material is set to be large in order to improve the battery capacity per unit area. In addition, in a conventional lithium ion secondary battery, since the metal foil and the active material have to be electrically in contact for effectively utilizing the active material, the active material is mixed with the conduction aid to be used. On the other hand, since the three-dimensional network metal porous body for a current collector of the present invention has a high degree of porosity and a large surface area size per unit area, a contact area between the current collector and the active material is enlarged. Therefore, the active material can be effectively utilized, thereby improving the capacity of the battery, and reducing the amount of the conduction aid to be mixed.

### EXAMPLES

Hereinafter, the present invention will be described in more detail based on Examples. However, such Examples are merely provided for the purpose of illustration, and the present invention is not limited thereto. The present invention includes meaning equivalent to the scope of the claims and all modifications within the scope.

Hereinafter, although a secondary battery having a solid electrolyte as a nonaqueous electrolyte is shown as an example, it can be easily understood by a person skilled in the art that a secondary battery having a nonaqueous electrolytic solution as a nonaqueous electrolyte also exhibits the same effect as those of the secondary batteries in the following Examples can also be obtained.

The metal forming the current collector for positive electrodes and the metal forming the current collector for negative electrodes can be appropriately selected in accordance with the combination with the active material. Preferable examples include a combination of a positive electrode having lithium cobalt oxide as the positive electrode active material and an aluminum porous body as the current collector of positive electrode, and a negative electrode having lithium titanium oxide as the negative electrode active material and a copper porous body as the current collector of negative electrode. Thus, hereinafter, the present invention will be described with an example of a secondary battery having a positive electrode having lithium cobalt oxide as the positive electrode active material and an aluminum porous body as the current collector of positive electrode, and lithium titanium oxide as the negative electrode active material and a copper porous body as the current collector of negative electrode.

### Example 1

### Production of Aluminum Porous Body 1

(Nonwoven fabric)

A nonwoven fabric (thickness: 1 mm, degree of porosity: 94%, weight of nonwoven fabric per unit area: 60 g/m², 30%-cumulative pore diameter (D30): 32 μm) was obtained, by using a PP/PE core-in-sheath composite fiber (fiber length: 10 mm, fiber diameter: 2.2 dTex (17 μm), core-sheath ratio: 1/1).

### (Formation of Conductive Layer)

By a sputtering method, a film was formed by depositing, on the surface of the resulting nonwoven fabric, aluminum at a weight per unit area of 10 g/m², to form a conductive layer.

(Molten Salt Plating)

The nonwoven fabric which had the conductive layer formed on the surface thereof was used as a workpiece. After the workpiece was set in a jig having an electricity supply function, the jig was placed in a glovebox maintained with an argon atmosphere and a low moisture condition (dew point: −30° C. or lower), and immersed in a molten salt aluminum plating bath (composition: 33 mol % of 1-ethyl-3-methyl imidazolium chloride (EMIC) and 67 mol % of AlCl₃) at a temperature of 40° C. The jig holding the workpiece was connected to the cathode of a rectifier, and an aluminum plate (purity: 99.99%), which is the counter electrode, was connected to the anode. Next, a plating was applied by passing a direct current between the workpiece and the counter electrode at a current density of 3M A/dm² for 90 minutes while stirring the molten salt aluminum plating bath, to give an “aluminum-resin complex porous body 1” having an aluminum plating layer (weight of the aluminum plating per unit area: 150 g/m²) formed on the surface of the nonwoven fabric. Stirring of the molten salt aluminum plating bath was performed by using a stirrer and a rotor made of Teflon (Registered Trademark). The current density is a value calculated using an apparent area of the surface of the nonwoven fabric.

(Decomposition of Nonwoven Fabric)

The “aluminum-resin complex porous body 1” was immersed in LiCl—KCl eutectic molten salt at a temperature of 500° C. Then, a negative potential of −1 V was applied to the “aluminum-resin complex porous body 1” for 30 minutes. Air bubbles resulting from a decomposition reaction of the resin forming the nonwoven fabric were generated in the molten salt. Thereafter, the resulting product was cooled to a room temperature in the atmosphere, and then washed with water to remove the molten salt from the product, thereby giving an “aluminum porous body 1” having removed therefrom the resin (nonwoven fabric) and consisting of aluminum.

The degree of porosity of the “aluminum porous body 1” was 94%. The 30%-cumulative pore diameter (D30) of the “aluminum porous body 1” was 29 μm.

### Example 2

### Production of Aluminum Porous Body 2

An “aluminum porous body 2” was obtained by performing the same operation as in Example 1 except for using, as the nonwoven fabric, a nonwoven fabric (thickness: 1 mm, degree of porosity: 97%, weight per unit area: 30 g/m², 30%-cumulative pore diameter (D30): 142 μm), the nonwoven fabric being obtained by using a PP/PE composite fiber (fiber length: 50 mm, fiber diameter: 4.4 dTex (25 μm), core-sheath ratio: 1/1).

The degree of porosity of the “aluminum porous body 2” was 94%. The 30%-cumulative pore diameter (D30) of the “aluminum porous body 2” was 130 μm.

### Comparative Example 1

### Production of Aluminum Porous Body 3

### (Formation of Conductive Layer)

By a sputtering method, a conductive layer was formed by depositing Aluminum at a weight per unit area of 10 g/m², on a surface of a polyurethane foam (degree of porosity: 97%, thickness: 1 mm, number of pores per inch: 30 (pore diameter 847 μm)).

(Molten Salt Plating)

The polyurethane foam which had the conductive layer formed on the surface thereof was used as a workpiece. After the workpiece was loaded in a jig having a electricity supply function, the jig was placed in a glovebox which was kept in an argon atmosphere and a low moisture condition (dew point: −30° C. or lower), and immersed in a molten salt aluminum plating bath (composition: 33 mol % of EMIC and 67 mol % of AlCl₃) at a temperature of 40° C. The jig holding the workpiece was set was connected to the cathode of a rectifier, and an aluminum plate (purity: 99.99%), which is the counter electrode, was connected to the anode. Next, a plating was applied by passing a direct current between the workpiece and the counter electrode at a current density of 3.6 A/dm² for 90 minutes while stirring the molten salt aluminum plating bath, to give an “aluminum-resin complex porous body 3” having an aluminum plating layer (weight of the aluminum plating per unit area: 150 g/m²) formed on the surface of the polyurethane foam. Stirring was performed by using a stirrer and a rotor made from Teflon (Registered Trademark). The current density is a value calculated using an apparent area of the polyurethane foam.

(Decomposition of Polyurethane Foam)

The “aluminum-resin complex porous body 3” was immersed in LiCl—KCl eutectic molten salt at a temperature of 500° C. Then, a negative potential of −1 V was applied thereto for 30 minutes. Air bubbles resulting from a decomposition reaction of the polyurethane foam were generated in the molten salt. Thereafter, the resulting product was cooled to a room temperature in the atmosphere, and then washed in water for removing the molten salt from the product, thereby giving an “aluminum porous body 3” having removed therefrom the polyurethane foam.

The degree of porosity of the “aluminum porous body 3” was 94%. The 30%-cumulative pore diameter (D30) of the “aluminum porous body 3” was 785 μm.

### Example 3

### Production of Copper Porous Body 1

By a sputtering method, a conductive layer was formed by depositing copper at a weight per unit area of 10 g/m², on the surface of the nonwoven fabric used in Example 1. Next, a copper plating layer (weight of copper per unit area: 400 g/m²) was formed by an electroplating method on the surface of the nonwoven fabric, thereby giving a “copper-resin complex porous body 1”. The resulting “copper-resin complex porous body 1” was heated to remove the nonwoven fabric through incineration. Then, the resulting product was heated in a reducing atmosphere to reduce the copper, thereby giving a “copper porous body 1” consisting of copper.

The degree of porosity of the “copper porous body 1” was 96%. The 30%-cumulative pore diameter (D30) of the “copper porous body 1” was 30 μm.

### Example 4

### Production of Copper Porous Body 2

By a sputtering method, a conductive layer was formed by depositing copper at a weight per unit area of 10 g/m², on the surface of the nonwoven fabric used in Example 2. Next, a copper plating layer (weight of copper per unit area: 400 g/m²) was formed by an electroplating method on the surface of the nonwoven fabric, thereby giving a “copper-resin complex porous body 2”. The resulting “copper-resin complex porous body 2” was heated to remove the nonwoven fabric through incineration. Then, the resulting product was heated in a reducing atmosphere to reduce the copper, and a “copper porous body 2” consisting only from copper was obtained.

The degree of porosity of the “copper porous body 2” was 96%. The 30%-cumulative pore diameter (D30) of the “copper porous body 2” was 139 μm.

### Comparative Example 2

### Production of Copper Porous Body 3

By using a sputtering method, a conductive layer was formed by depositing copper at a weight per unit area of 10 g/m², on the surface of the polyurethane foam used in Comparative Example 1. Next, a copper plating layer (weight of copper per unit area: 400 g/m²) was formed by an electroplating method on the surface of the polyurethane foam, thereby giving a “copper-resin complex porous body 3.” The resulting “copper-resin complex porous body 3” was heated to remove the polyurethane foam through incineration. Then, the resulting product was heated in a reducing atmosphere to reduce the copper, thereby giving a copper porous body 3″ consisting of copper.

The degree of porosity of the “copper porous body 3” was 96%. The 30%-cumulative pore diameter (D30) of the “copper porous body 3” was 788 μm.

The 30%-cumulative pore diameter (D30) and the degree of porosity of each of the porous bodies of Examples 1 to 4 and Comparative Examples 1 and 2 are shown in Table 1. In the table, “2.2 dTex” indicates 17 μm and “4.4 dTex” indicates 25 μm.

TABLE 1

| | | | | | Weight |
|---|---|---|---|---|---|
| | | | Degree | | per |
| | | | of | | unit |
| | | D30 | porosity | | area |
| | Type | [μm] | [%] | Base material | [g/m²] |
| Exam- | Alu- | 29 | 94 | Nonwoven fabric | 150 |
| ple 1 | minum | | | Fiber length: 10 mm, | |
| | porous | | | Fiber diameter: 2.2dTex | |
| | body 1 | | | Thickness: 1 mm, | |
| | | | | Degree of porosity: 94% | |
| | | | | Weight per unit area: | |
| | | | | 60 g/m², | |
| | | | | D30 = 32 μm | |
| Exam- | Alu- | 130 | 94 | Nonwoven fabric | 150 |
| ple 2 | minum | | | Fiber length: 50 mm, | |
| | porous | | | Fiber diameter: 4.4dTex | |
| | body 2 | | | Thickness: 1 mm, | |
| | | | | Degree of porosity: 97% | |
| | | | | Weight per unit area: | |
| | | | | 30 g/m², | |
| | | | | D30 = 142 μm | |
| Compar- | Alu- | 785 | 94 | Polyurethane foam | 150 |
| ative | minum | | | Thickness: 1 mm, | |
| Exam- | porous | | | Degree of porosity: 97% | |
| ple 1 | body 3 | | | 30 cells/inch, | |
| | | | | Cell diameter: 847 μm | |
| Exam- | Copper | 30 | 96 | Nonwoven fabric | 400 |
| ple 3 | porous | | | Fiber length: 10 mm, | |
| | body 1 | | | Fiber diameter: 2.2dTex | |
| | | | | Thickness: 1 mm, | |
| | | | | Degree of porosity: 94% | |
| | | | | Weight per unit area: | |
| | | | | 60 g/m², | |
| | | | | D30 = 32 μm | |
| Exam- | Copper | 139 | 96 | Nonwoven fabric | 400 |
| ple 4 | porous | | | Fiber length: 50 mm, | |
| | body 2 | | | Fiber diameter: 4.4dTex | |
| | | | | Thickness: 1 mm, | |
| | | | | Degree of porosity: 97% | |
| | | | | Weight per unit area: | |
| | | | | 30 g/m², | |
| | | | | D30 = 142 μm | |
| Compar- | Copper | 788 | 96 | Polyurethane foam | 400 |
| ative | porous | | | Thickness: 1 mm, | |
| Exam- | body 3 | | | Degree of porosity: 97% | |
| ple 2 | | | | 30 cells/inch, | |
| | | | | cell diameter: 847 μm | |

From the results shown in Table 1, it can be understood that the 30%-cumulative pore diameter (D30) can be reduced by forming the metal coating on the surface of the nonwoven fabric to give a complex of the nonwoven fabric and the metal coating, and then degrading to remove the nonwoven fabric from the complex, as in the cases in Examples 1 to 4, compared to the cases (Comparative Examples 1 and 2) where a polyurethane foam was used in place of the nonwoven fabric as done conventionally.

### Example 5

### Production of Positive Electrode 1

A powder (mean particle diameter: 5 μm) of lithium cobalt oxide was used as the positive electrode active material. The powder of the lithium cobalt oxide (positive electrode active material), Li₂S.P₂S₂ (solid electrolyte), acetylene black (conduction aid), and PVDF (binder) were mixed at a mass ratio (positive electrode active material/solid electrolyte/conduction aid/binder) of 55/35/5/5. To the resulting mixture, N-methyl-2-pyrrolidone (organic solvent) was added dropwise. Thereafter, the resulting mixture was mixed to prepare a paste-like positive electrode mixture slurry. Next, the resulting positive electrode mixture slurry was supplied to the surface of the “aluminum porous body 1”. The resulting product was pressed under the load of 5 kg/cm² by using a roller, thereby filling the pores of the “aluminum porous body 1” with the positive electrode mixture. Then, the “aluminum porous body 1” filled with the positive electrode mixture was dried for 40 minutes at 100° C. to remove the organic solvent, thereby giving a “positive electrode 1”.

### Example 6

### Production of Positive Electrode 2

A powder (mean particle diameter: 5 μm) of lithium cobalt oxide was used as the positive electrode active material. The powder of the lithium cobalt oxide (positive electrode active material), Li₂S.P₂S₂ (solid electrolyte), acetylene black (conduction aid), and PVDF (binder) were mixed at a mass ratio (positive electrode active material/solid electrolyte/conduction aid/binder) of 55/35/5/5. To the resulting mixture, N-methyl-2-pyrrolidone (organic solvent) was dropwise. Thereafter, the resulting mixture was mixed to prepare a paste-like positive electrode mixture slurry. Next, the resulting positive electrode mixture slurry was supplied to the surface of the “aluminum porous body 2”. The resulting product was pressed under the load of 5 kg/cm² by a roller, thereby filling the pores of the “aluminum porous body 2” with the positive electrode mixture. Thereafter, the “aluminum porous body 2” filled with the positive electrode mixture was dried for 40 minutes at 100° C. to remove the organic solvent, thereby giving a “positive electrode 2.”

### Comparative Example 3

### Production of Positive Electrode 3

A “positive electrode 3” was obtained by performing the same operation as in Example 5 except for using the “aluminum porous body 3” in place of the “aluminum porous body 1” used in Example 5.

### Example 7

### Production of Negative Electrode 1

A powder (mean particle diameter: 5 μm) of lithium titanium oxide was used as the negative electrode active material. The powder of the lithium titanium oxide (negative electrode active material), Li₂S.P₂S₂ (solid electrolyte), acetylene black (conduction aid), and PVDF (binder) were mixed at a mass ratio (negative electrode active material/solid electrolyte/conduction aid/binder) of 55/35/5/5. To the resulting mixture, N-methyl-2-pyrrolidone (organic solvent) was added dropwise. Thereafter, the resulting mixture was mixed to prepare a paste-like negative electrode mixture slurry. Next, the resulting negative electrode mixture slurry was supplied to the surface of the “copper porous body 1.” The resulting product was pressed under the load of 5 kg/cm² by using a roller, thereby filling the pores of the “copper porous body 1” with the negative electrode mixture. Thereafter, the “copper porous body 1” filled with the negative electrode mixture was dried for 40 minutes at 100° C. to remove the organic solvent, thereby giving a “negative electrode 1.”

### Example 8

### Production of Negative Electrode 2

A powder (mean particle diameter: 5 μm) of lithium titanium oxide was used as the negative electrode active material. The powder of the lithium titanium oxide (negative electrode active material), Li₂S.P₂S₂ (solid electrolyte), acetylene black (conduction aid), and PVDF (binder) were mixed at a mass ratio (negative electrode active material/solid electrolyte/conduction aid/binder) of 55/35/5/5. To the resulting mixture, N-methyl-2-pyrrolidone (organic solvent) was dropwise. Thereafter, the resulting mixture was mixed to prepare a paste-like negative electrode mixture slurry. Next, the negative electrode mixture slurry was supplied to the surface of the “copper porous body 2.” Thereafter, the resulting product was pressed under the load of 5 kg/cm² by using a roller, thereby filling the pores of the “copper porous body 2” with the negative electrode mixture. Then, the “copper porous body 2” filled with the negative electrode mixture was dried for 40 minutes at 100° C. to remove the organic solvent, thereby giving a “negative electrode 2.”

### Comparative Example 4

### Production of Negative Electrode 3

A “negative electrode 3” was obtained by performing the same operation as in Example 7, except for using the “copper porous body 3” in place of the “copper porous body 1” used in Example 7.

### Production Example 1

### <Production of Solid Electrolyte Film 1> by Pressurizing and Molding

A “solid electrolyte film 1” was obtained by grinding Li₂S.P₂S₂ (solid electrolyte), which is a lithium ion conductive glassy solid electrolyte, with a use of a mortar to have a size of 100-mesh or less, and pressurizing and molding the ground Li₂S.P₂S₂ in a disk shape having a diameter of 10 mm and a thickness of 1.0 mm.

### Example 9

The “positive electrode 1”, the “negative electrode 1”, and the “solid electrolyte film 1” sandwiched therebetween were pressure-welded to produce an “all-solid lithium secondary battery 1”.

### Example 10

The “positive electrode 2”, the “negative electrode 2”, and the “solid electrolyte film 1” sandwiched therebetween were pressure-welded to produce an “all-solid lithium secondary battery 2.”

### Comparative Example 5

The “positive electrode 3”, the “negative electrode 3”, and the “solid electrolyte film 1” sandwiched therebetween were pressure-welded to produce an “all-solid lithium secondary battery 3.”

### Experimental Example 1

The internal resistances of batteries and the internal resistances of batteries were measured for the all-solid lithium secondary batteries obtained in Examples 9 and 10 and Comparative Example 5. The results are shown in Table 2.

TABLE 2

| | | | | Internal |
|---|---|---|---|---|
| | | Positive | Negative | resistance |
| | Type of battery | electrodes | electrodes | (Ω · dm) |
| Example 9 | All-solid lithium | Positive | Negative | 1.00 |
| | secondary | electrode 1 | electrode 1 | |
| | battery 1 | | | |
| Example 10 | All-solid lithium | Positive | Negative | 1.32 |
| | secondary | electrode 2 | electrode 2 | |
| | battery 2 | | | |
| Comparative | All-solid lithium | Positive | Negative | 2.43 |
| Example 5 | secondary | electrode 3 | electrode 3 | |
| | battery 3 | | | |

From the results shown in Table 2, it can be understood that the all-solid lithium secondary batteries (Examples 9 and 10) having, as current collectors, the metal three-dimensional network porous bodies for a current collector (Examples 1 to 4) of the present invention have internal resistances that are smaller than the internal resistance of the all-solid lithium secondary battery obtained in Comparative Example 5.

### INDUSTRIAL APPLICABILITY

A secondary battery having the three-dimensional network metal porous body for a current collector according to the present invention can be suitably used as power supply for portable electronic equipment such as mobile phones and smart phones, and electric vehicles and hybrid electric vehicles utilizing a motor as a source of power.

### REFERENCE SIGNS LIST

1 POSITIVE ELECTRODE
2 NEGATIVE ELECTRODE
3 SEPARATOR (IONIC CONDUCTION LAYER)
4 ELECTRODE LAMINATE
5 POSITIVE ELECTRODE ACTIVE MATERIAL POWDER
6 CONDUCTIVE POWDER
7 CURRENT COLLECTOR OF POSITIVE ELECTRODE
8 NEGATIVE ELECTRODE ACTIVE MATERIAL POWDER
9 CURRENT COLLECTOR OF NEGATIVE ELECTRODE
10 SECONDARY BATTERY
60 LITHIUM BATTERY
61 POSITIVE ELECTRODE
62 NEGATIVE ELECTRODE
63 SOLID ELECTROLYTE LAYER (SE LAYER)
64 POSITIVE ELECTRODE LAYER (POSITIVE ELECTRODE BODY)
65 CURRENT COLLECTOR OF POSITIVE ELECTRODE
66 NEGATIVE ELECTRODE LAYER
67 CURRENT COLLECTOR OF NEGATIVE ELECTRODE

1. A three-dimensional network metal porous body for a current collector, comprising a sheet-shaped three-dimensional network metal porous body, wherein a degree of porosity of the sheet-shaped three-dimensional network metal porous body is 90% or more 98% or less, and a 30%-cumulative pore diameter (D30) of the sheet-shaped three-dimensional network metal porous body calculated by carrying out a fine pore diameter measurement with a bubble point method is 20 μm or more and 100 μm or less.

2. The three-dimensional network metal porous body for a current collector according to claim 1, wherein the 30%-cumulative pore diameter (D30) is 20 μm or more and 60 μm or less.

3. The three-dimensional network metal porous body for a current collector according to claim 1, wherein the sheet-shaped three-dimensional network metal porous body is obtained by forming a metal coating on a nonwoven fabric, and then degrading to remove the nonwoven fabric.

4. An electrode comprising the three-dimensional network metal porous body for a current collector according to claim 1, wherein the three-dimensional network metal porous body is filled with an active material or a mixture of an active material and a nonaqueous electrolyte.

5. A nonaqueous electrolyte secondary battery comprising a positive electrode, a negative electrode, and a nonaqueous electrolyte, wherein the positive electrode and/or the negative electrode are/is the electrode according to claim 4.

6. The nonaqueous electrolyte secondary battery according to claim 5, wherein:
an active material of the positive electrode is at least one material selected from the group consisting of lithium cobalt oxide (LiCoO₂), lithium nickel oxide (LiNiO₂), lithium nickel cobalt oxide (LiCoₓNi₁₋ₓO₂; 0<x<1), lithium manganese oxide (LiMn₂O₄), and a lithium manganese oxide compound (LiM_{y}Mn_{2-y}O₄; M=Cr, Co, or Ni; 0<y<1); and
an active material of the negative electrode is graphite, lithium titanium oxide (Li₄Ti₅O₁₂), a metal or an alloy,
the metal being selected from the group consisting of Li, In, Al, Si, Sn, Mg, and Ca, and the alloy containing at least one of the metals.

7. The nonaqueous electrolyte secondary battery according to claim 5, wherein the nonaqueous electrolyte is a solid electrolyte.

8. The nonaqueous electrolyte secondary battery according to claim 7, wherein the solid electrolyte is a sulfide solid electrolyte containing lithium, phosphorus, and sulfur as constituent elements.

9. The nonaqueous electrolyte secondary battery according to claim 7, wherein a three-dimensional network metal porous body for a current collector of the positive electrode is made of aluminum, and a three-dimensional network metal porous body for a current collector of the negative electrode is made of copper.

10. The nonaqueous electrolyte secondary battery according to claim 9, wherein the three-dimensional network metal porous body for a current collector of the positive electrode is obtained by forming an aluminum coating on a surface of a nonwoven fabric through molten salt plating to obtain a complex of the nonwoven fabric and the aluminum coating, and then degrading to remove the nonwoven fabric from the complex.
